(19) United States
(12) Patent Application Publication
(10) Pub. No.: US 2023/0342165 A1
(43) Pub. Date: Oct. 26, 2023

(54) DYNAMIC NESTED PLAYLIST RENDERING AND NOTIFICATION SYSTEM

(71) Applicants: Aric Huang, Walnut Creek, CA (US); Craig Huff, Nelson (CA); Jordan Schroter, Kitchener (CA)

(72) Inventors: Aric Huang, Walnut Creek, CA (US); Craig Huff, Nelson (CA); Jordan Schroter, Kitchener (CA)

(73) Assignee: Raydiant, Inc., San Fransisco, CA (US)

(21) Appl. No.: 17/729,150

(22) Filed: Apr. 26, 2022

(51) Int. Cl. G06F 3/0482; G06F 9/451; G06V 20/70

(52) U.S. Cl. CPC G06F 9/451; G06F 3/0482; G06V 20/70; G06F 2203/011

(57) ABSTRACT

A dynamic nested playlist display system is disclosed comprising an input-output interface configured to communicate with a sensor and a display; a memory configured to store dynamic nested playlists, rules, and tags, the tags associated with one or more of the dynamic nested playlists and the display; an electronic processor coupled to the input-output interface and the memory, the electronic processor configured to select a suitable dynamic nested playlist by correlating one or more of the tags of the dynamic nested playlist to one or more tags associated with the display according to one or more of the rules. The electronic processor is also configured to communicate presentation data included in the suitable dynamic playlist to the display.

### TECHNICAL FIELD

The embodiments generally relate to methods of targeting presentations at one or more observers based on display context and observer traits.

### BACKGROUND

Communication to consumer observers via displays, billboards, or electronic communication devices lacks dynamic content targeted toward specific observers in proximity of the device.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide for a dynamic nested playlist system.

A dynamic nested playlist system may include an input-output interface configured to communicate with a sensor and a display; a memory configured to store dynamic nested playlists, rules, and tags, the tags associated with one or more of the dynamic nested playlists and the display; an electronic processor coupled to the input-output interface and the memory, the electronic processor configured to select a suitable dynamic nested playlist by correlating one or more of the tags of the dynamic nested playlist to one or more tags associated with the display according to one or more of the rules; communicate presentation data included in the suitable dynamic playlist to the display.

A method of displaying a dynamic presentation to a target observer may include selecting, via the electronic processor, a dynamic nested playlist for display based on the correlating of a tag associated with the dynamic nested playlist to a tag associated with a display according to one or more rules; and, displaying, via the display, the dynamic nested playlist based on the selection of the dynamic nested playlist.

A non-transitory computer readable medium that, when executed by an electronic processor, is configured to perform a set of functions, may perform the set of functions including selecting a dynamic nested playlist for display based on the correlating of a tag associated with the dynamic nested playlist to a tag associated with a display according to one or more rules; and, displaying the dynamic nested playlist based on the selection of the dynamic nested playlist via a display.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A complete understanding of the present embodiments and the advantages and features thereof will be more readily understood by reference to the following detailed description when considered in conjunction with the accompanying drawings wherein:

FIG. 1 illustrates a dynamic nested playlist system configured to support the disclosed dynamic nested playlist rendering and notification system according to a variety of embodiments disclosed herein.

FIG. 2 illustrates a graphical user interface of a dynamic nested playlist system configured to allow a user to create and assign tags to a playlist and a presentation of the playlist.

FIG. 3 illustrates a graphical user interface of a dynamic nested playlist system configured to allow a user to create and assign tags to a display device.

FIG. 4 illustrates a graphical user interface of a dynamic nested playlist system configured to allow a user to create and assign tags to a display device.

FIG. 5 illustrates a diagram of a dynamic nested playlist system communicating with a plurality displays using a variety of dynamic nested presentation playlists according to a variety of embodiments described herein.

FIG. 6 illustrates an array of displays disposed on a wall, the array of displays configured to capture images, perform image analysis, and display advertisements from a dynamically generated presentation playlist targeted at the subject of the images.

FIG. 7 illustrates a flowchart for an electronic processor automatically generating or selecting a dynamic nested presentation playlist.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a dynamic nested playlist system that is configured to determine where and on which displays to display a presentation or a playlist of presentations (sometimes nested within a dynamically changing master playlists). This determination may be made based on one or more rules (that may be user-defined) evaluating the tag names and tag values of a number of tags associated with the presentations, the playlists, the master playlists, and the displays.

As used herein, the term “user(s)” may refer to an individual or entity who directly interacts with a graphical user interface of the system disclosed herein. The term “user(s)” may also refer to an individual or entity indirectly interacting with the disclosed system (e.g., a venue patron that the disclosed system collects data on).

As used herein, “GUI” may refer to any graphical user interface that includes at least one interactive component between a user and the application. A GUI may include a plurality of fillable fields, clickable buttons, database displays, or the like. A GUI maybe adaptable for use on several devices such as computers, phones, smart devices, tablets, laptops, televisions, or the like.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, “controller” may include a system including an electronic processor and configured to produce and/or execute control signals. Such a controller may be a distributed computing device such as a cloud computing system, or a localized computing system such as a field programmable gate array. The term “controller” as used herein may include a hybrid control system comprising, for example, edge computing devices configured to communicate with a remote computing system (e.g., a cloud computing system) and to share any described control tasks with the remote computing system.

In some embodiments, the methods described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integrated into the processor. Further, in some embodiments, the processor and the storage medium may reside in an Application Specific Integrated Circuit (ASIC). The processor and the storage medium may also reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, computer readable instructions executable by a controller and configured to carry out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The executable instructions can execute entirely on the user’s computer, partly on the user’s computer, as a stand-alone software package, partly on the user’s computer and partly on a remote computer, or entirely on the remote computer or server. In the latter scenario, the remote computer can be connected to the user’s computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the executable instructions can be downloaded to a computing/processing device from a computer readable storage medium, or to an external computer or external storage device via a network. A network adapter card or network interface in each computing/processing device receives computer readable program instructions from the network and forwards the computer readable executable instructions for storage in a computer readable storage medium within the respective computing/processing device.

Any connection between the components of the disclosed system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

As used herein, “dynamic presentation” refers to a collection of one or more items of content (e.g., images, slides, etc.) to be presented via a display according to a chosen playback mode (e.g., sequential, random, numerical, alphabetical). This collection of one or more items of content can be expanded or pared down dynamically (e.g., during a run time of host software). As used herein, “dynamic playlist” refers to a collection of one or more dynamic presentations to be presented via a display according to a chosen playback mode. This collection of one or more dynamic presentations can also be expanded or pared down dynamically. As used herein “dynamic nested playlist” refers to a collection of one or more dynamic playlists to be presented via a display according to a chosen playback mode. This collection of one or more dynamic playlists can also be expanded or pared down dynamically. Additionally, a parent dynamic nested playlist may contain one or more child dynamic nested playlists. Dynamic nested playlists can technically nest infinitely, there is no maximum depth. Thus, herein, dynamic nested playlists may be considered modular content blocks. As will be described in further detail below, the modular nature of the dynamic nested playlists greatly streamlines content management for a user, who can simply add or remove these modular content blocks to a parent playlist as needed.

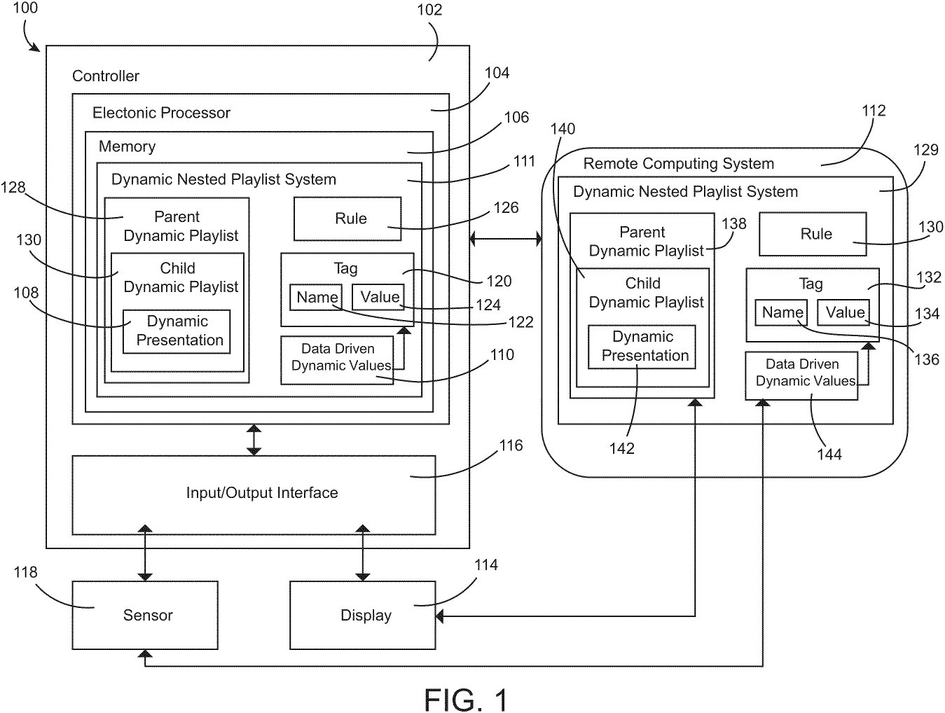

In reference to FIG. 1, a dynamic nested playlist system 100 comprises a controller 102 including an electronic processor 104 and an input/output interface 116. The input/output interface 116 is configured to receive data from sensor 118, and an electronic processor of the controller 102 is configured to create and update data driven dynamic tag values 110 in a memory 106 of the electronic processor 104 based on the received data. The memory 106 is configured to store a dynamic nested playlist system 111 including tags 120 having names 122 and one or more values 124, rules 126, dynamic nested playlists including parent dynamic playlists 128 including child dynamic playlists 130 (referred to herein collectively as “dynamic nested playlists”), dynamic presentations 108, and data driven dynamic tag values 110. The tags 120 are a key-value pair having a name 122 (key) and one or more associated values 124 that can be associated with dynamic nested playlists 128, 130, dynamic presentations 108, and displays 114. For example, a tag 120 may have a name “campaign” and a plural value of “motorcycles|boats” (i.e., motorcycles AND boats) The controller 102, via the dynamic nested presentation system 111 is configured to access displays 114, dynamic nested playlists 128, 130, and dynamic presentations 108, using the names 122 and values 124 tags 120 in accordance with rules 126. In this way, the controller 102 determines what to display to target observants (not shown) via a display 114. The input/output interface 116 is configured to serve as a communication interface between the controller 102 and the display 114. A remote computing system 112, also comprises a dynamic nested presentation system 129 including rules 130, tags 132 having names 134 and values 136, nested dynamic playlists 138, 140, and dynamic presentations 142, is configured to send data to and receive data from the electronic processor 104 and may also be configured to send data to and receive data from the sensor 118 and the display 114. The remote computing system 112 may also be configured to analyze any received data, according to the methods disclosed here in, and to communicate the results of that analysis to the controller 102, or to access displays 114, dynamic nested playlists 134, 136, and dynamic presentations 138 associated with tags 132 based on rules 130.

In some embodiments, the disclosed system is configured to communicate with a network. In some embodiments, a network interface is configured to allow data to be exchanged between the controller 100 and other devices attached to the network, such as other computer systems, or between nodes of the computer controller 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

In some embodiments, the above referenced network corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network may comprise copper transmission cables, optical transmission fibers, wireless transmission, routers, firewalls, switches, gateway computers and/or edge servers. The network may represent a single network or multiple networks.

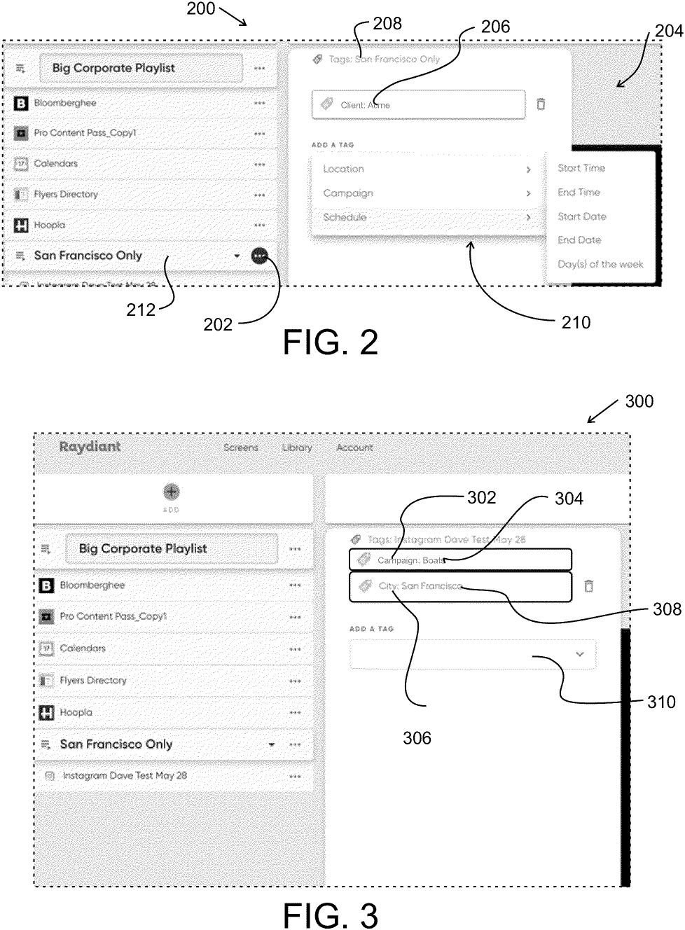

In reference to FIG. 2, a graphical user interface (GUI) 200 allows a user to select and edit the tags associated with a dynamic presentation 108, 142 within a dynamic nested playlist 128, 130, 138, 140, or with the dynamic nested playlist 128, 130, 138, 140 itself. As described herein, In the variation shown, an editing icon 202 associated with the “San Francisco Only” playlist is selected. A playlist tag editing window 204 is opened in the GUI 200. The playlist tag editing window 204 allows a user (not shown) to select and edit tags 120, 132 for association with a dynamic nested playlist 128, 130, 138, 140. In the variation shown, a tag 120, 132 representing a client name, having the tag value 124, 134 (“ACME”) 208 and a tag 120, 132 representing a location, having the tag value 124, 134 (“San Francisco”) 210 are already associated with the dynamic nested playlist 128, 130, 138, 140. A drop-down box 210 allows the user to select additional tags 120, 132 to associate with the selected dynamic nested playlist 212. Rules 126, 130 compare tags 120, 132 on a display 114 with tags on presentations or playlists. If a rule 126, 130 evaluates to true, then the dynamic nested playlist 128, 130, 138, 140 or dynamic presentation 108, 142 is displayed via the display. Rules 126, 130 may be evaluated according to an order of operations and may include boolean operators such as AND OR, so an operator (not shown) can build up complex rules 126, 130 that include multiple variables. An example would be a rule 126, 130 that includes time schedule components (e.g., determining the time at which a presentation should be displayed) as well as specific tags 120, 132 related to the content of a dynamic nested playlist 128, 130, 138, 140, as well as location of the display 114. Rules 126, 130 can be applied such that they are applied to an entire dynamic nested playlist 128, 130, 138, 140, or applied to one dynamic presentation 108, 142 at a time. Rules 126, 130 may be validated mathematically and checked for syntax validity before being stored.

In reference to FIG. 3, a graphical user interface (GUI) 300 allows a user to select a dynamic presentation 108, 142 and select and edit tags 120, 132 for association with the dynamic presentation 108, 142. In the variation shown, a tag 120, 132 having the tag name 122, 136 “campaign” 302 and having the tag value 124, 134 “boats” 304 and a tag having the tag name 122, 136 “city” 306 and having the tag value 124, 134 “San Francisco” 308 are already associated with the dynamic nested playlist 128, 130, 138, 140. A drop-down box 310 allows the user to select additional tags 120, 132 to associate with the selected dynamic nested playlist 128, 130, 138, 140 in a manner similar to that shown in FIG. 2. In some embodiments, the GUI 300 can be used to associate tags 120, 132, having data driven dynamic values 110, 142 with a dynamic nested playlist 128, 130, 138, 140.

As will be described in greater detail below, the GUI 200, 300, shown in FIGS. 2 and 3 as example embodiments, may allow a user to customize the dynamic nested playlist system 111, 114 by creating and editing tags and assigning them to display devices, dynamic playlists, and dynamic presentations. The tags can pertain to particular events (e.g., Law Conferences), locations (e.g., Detroit), platforms (e.g., streaming services), schedules (e.g., times of day, days of year), ad campaigns (e.g., promotion of a new product), etc.

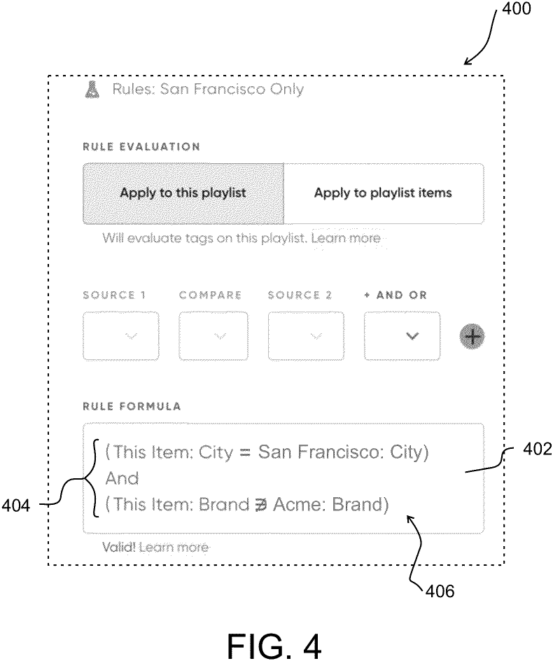

In reference to FIG. 4, the GUI 400 may also allow a user to create rules and apply them to dynamic nested playlists 128, 130, 138, 140 and dynamic presentations 108, 142 by selecting displays 114, dynamic nested playlists 128, 130, 138, 140, or dynamic presentations 108, 142 as sources (e.g., subjects and objects) of the rule 126, 130, and selecting a comparison semantic (e.g., is equal to, is less than, includes, does not include, etc.). As shown in FIG. 4, in some embodiments, multiple rules may be stacked with and/or logic. This will be discussed in more detail below. As also shown in FIG. 4, the GUI 400 may also include a text box 402 where rule semantics 404 may be typed directly. In the embodiment shown, a rule 406 is shown specifying that items in this playlist should be items associated with the San Francisco location tag, and that this playlist should only play on devices that are not ACME brand.

During operation, the dynamic nested playlist system 111, 129 correlates the names and values of one or more tags 120, 132 associated with one or more dynamic nested playlists 128, 130, 138, 140 or dynamic presentations 108, 142 to the names and values of one or more tags 120, 132 associated with one or more displays 114 as a means of determining which content should be shown via one or more displays 114 in a plurality of locations. For example, a particular display 114 may be located in the District of Columbia. A sensor 118 on board the display 114 or associated with the display 114 may determine the location of the display 114 and update a data driven dynamic tag value 110, 144 to indicate that the location of the display 114 is “District of Columbia.” The dynamic nested playlist system 111, 129 may then automatically update the value of a tag 120, 132 associated with the display 114 and having the name “location” to indicate that the location of the display 114 is the city of Washington, in the District of Columbia (“DC”). Specifically, in the example immediately above, the dynamic nested playlist system may update the location tag associated with the display 114 to have a value “District of Columbia.” A user (e.g., an operator of the dynamic nested playlist system) may make a rule 406 applied to a particular dynamic nested playlist 128, 130, 138, 140 containing local DC political ads to the effect that displays in the District of Columbia should display the dynamic nested playlist 128, 130, 138, 140 (e.g., “This Playlist: City = Washington” AND “This Playlist: Campaign = Political”). The dynamic nested playlist system 111, 129 may then correlate that rule 406 to a display in DC associated with a tag having the name “event” and value “political.” In some embodiments, tags may be created to have a static timestamp value but a rule can be created to evaluate the tag 120, 132 in view of the current time. For example, a tag 120, 132 may be created with a tag name 122, 136 “showing time” and a tag value 124, 134 of “5 PM.” Such a tag 120, 132 may be associated with a dynamic nested playlist 128, 130, 138, 140 or a dynamic presentation 108, 142. Continuing with the example, a rule 406 may be created that correlates tags 120, 132 having a tag name 122, 136 “showing time” to the current local time, and selects the rules for display based on their tag value 122, 136. So, in the example above, the tagged dynamic nested playlist 128, 130, 138, 140 would be selected by the rule 406 for display at 5 PM. In some embodiments, a showing time tag value 122, 136 may be a time span or range.

In some embodiments, the frequency of play of dynamic nested playlists or dynamic presentations for a particular display can be controlled via a rule 406 referencing a data-driven dynamic tag 120, 132 that is updated, via and external system or local playback data, based on the playback of that very display. For example, a rule applied the to particular display 114 may state that only 50% of the ads displayed should be political. As political ads play on that display, a tag named “political ads displayed” may have its value incremented and correlated by a rule to the value of a tag named “total ads displayed” that is incremented with each new ad display by that particular display 114.

Further, the values of data-driven tags 120, 132 may be automatically updated for a dynamic presentation 108, 142 or dynamic nested playlist 128, 130, 138, 140 associated with the data-driven tag 120, 132 based on an analysis (e.g., image analysis, text analysis, audio analysis, source analysis, etc.) of the content of the dynamic presentation 108, 142 or dynamic nested playlist 128, 130, 138, 140. For example, the value of a tag 120, 132 associated with a dynamic nested playlist 128, 130, 138, 140 having the name “campaign” may be automatically updated to have a value of “political” by the dynamic nested playlist system 111, 129 if analysis performed by the dynamic nested playlist system 111, 129 on the dynamic presentation 108, 142 or dynamic nested playlist 128, 130, 138, 140 indicates that the dynamic presentation 108, 142 contains all political ads, or that the dynamic playlist 128, 130, 138, 140 contains a dynamic presentation 108, 142 wherein the quantity of political ads by volume exceeds a threshold. In such a case, the update to the tag 120, 132 may be proposed to a user for approval via a user interface, and, upon approval by a user, be associated with the dynamic nested playlist 128, 130, 138, 140.

In some embodiments, the controller 102 or remote computing system 112 may be configured to perform image analysis, text analysis, audio analysis, or source analysis of the dynamic presentation 120, 132 or the dynamic nested playlist 128, 130, 138, 140 with a predetermined granularity (e.g., on a image-wise basis, slide-wise basis, page-wise basis, etc.) and classify each analyzed grain (e.g., image, slide, page, etc.) as sufficiently related to a particular tag 120, 132, or not related to a tag 120, 132. For example, the controller 102 or the remote computing system 112 may analyze an image within a slide of a dynamic presentation 120, 132 and classify the image as related to a value of “Washington” for a tag 120, 132 associated with the dynamic presentation and having a name of “city”. The controller 102 or remote computing system 112 may also be configured to perform a similar analysis and classification on text, slide, page, etc. These classifications may then be weighted, grouped, and averaged by the controller 102 or remote computing system 112 to produce one or more tag 120, 132 values to associate with tags already associated with the dynamic presentation. In a similar way, using dynamic presentations 108, 142 as the level of granularity for the analysis, the value of tags 120, 132 associated with dynamic playlists 128, 130, 138, 140 may be automatically updated.

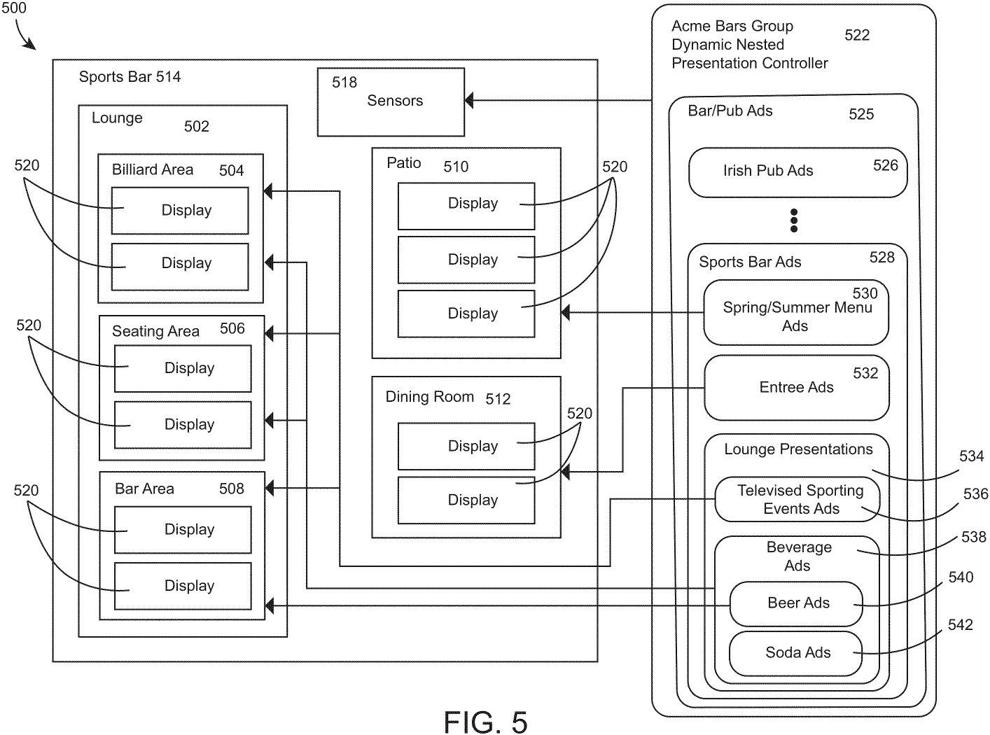

In reference to FIG. 5, a dynamic nested playlist system 500 is configured to select and display dynamic nested playlists 128, 130, 138, 140 for display on plurality of displays 114 in a plurality of spaces 502, 504, 506, 508, 510, 512 in a particular venue, specifically a sports bar 514. In the embodiment shown, sensors 518 disposed in the venue may be configured to collect data (e.g., image data, sound data, temperature data, lighting data, etc.). A dynamic nested presentation controller 520 may be configured to analyze the data collected via the sensors 518 or sound data (e.g., image analysis or sound analysis) to set the values of one or more data driven dynamic tag values 110, 144. In the embodiment shown, a sports bar 514 includes a lounge 502 including a billiards area 504, a seating area 506, and a bar area 508. The sports bar 514 also includes areas external to the long area 502 such as a patio 510 and a dining room 512. Each of these areas may be equipped with displays 520. Sensors 518 may be disposed throughout the sports bar 514 or concentrated in specific areas. A dynamic nested playlist system associated specifically with the management group of the sports bar 514, in this case the Acme Bars Group Dynamic Nested Playlist Controller 522, may be configured to generate, assemble, and select dynamic nested playlists 522, 524, 526, 528, 530, 532, 534, 536, 538, 540, 542 and dynamic presentations 108, 142 for display in the various areas 502, 504, 506, 508, 510, 512 of the sports bar 514 via the various displays 520 based on the data driven dynamic tag values 110. In the embodiment shown, an “area” aspect may be associated with each display 520. For example, each area of the sports bar 514 may be equipped with a sensor 518 configured to determine which of the various areas 502, 504, 506, 508, 510, 512, of the sports bar 514 that each display 520, is disposed in upon startup. Such sensors 518 may also be configured to associate that location with every data driven dynamic tag value 110 it creates or edits. Additionally, Acme Bars Group Dynamic Nested Playlist Controller 522 may be configured to maintain (e.g., generate or update) a set of data driven dynamic tag value 110 for each of the various areas of the sports bar 514 having sensors 518 disposed therein. Specifically, each of the various areas of the sports bar may have a “area.occupants” data driven dynamic tag value 110 configured to be automatically populated (e.g., based on sensor data) with a value indicating the number of occupants in the area based on an analysis of sensor data (e.g., image data such as infrared image data, motion sensor data, etc.) performed by the Acme Bars Group Dynamic Nested Playlist Controller 522. Similarly, each of the various areas of the sports bar may have an “area.size” data driven dynamic tag value 110 configured to be automatically populated with a value indicating the size of the area in which the sensor is disposed, based on an analysis of sensor data (e.g., distance sensor data, etc.) from sensors 518 associated with displays 520. Given that the entire sports bar 514 may be located in a particular region, a tag 120 having a tag value 124, 134 indicating the region in which the sports bar 514 is located may also be created and associated with every device 520 associated with the Acme Bars Group Dynamic Nested Playlist Controller 522. The value of this regional tag value 124, 134 may be factored into the determination, made by the Acme Bars Group Dynamic Nested Playlist Controller 522, of which dynamic nested playlists 522, 524, 526, 528, 530, 532, 534, 536, 538, 540, 542 to display via one or more of displays 520. For example, such a regional tag 120 may have a tag name 122, 136 of “area.season” indicating the current season in the region in which the sports bar 514 is located. This type of tag 120 may be considered a ‘global’ tag, and may have data driven dynamic tag value 110 updated by one of the sensors 518 in disposed in one of the various areas 502, 504, 506, 508, 510, 512 of the sports bar 514 or updated by the Acme Bars Group Dynamic Nested Playlist Controller 522 based on data associated with the sports bar 514 as a whole (e.g., an IP address, a geofence, a street address, etc.) Additionally, such ‘global’ tags may have a static tag value 124, 134 preset by a user.

The Acme Bars Group Dynamic Nested Playlist Controller 522 may use these tags 120, 132 (e.g., local, regional, global, etc.) with the various areas 502, 504, 506, 508, 510, 512 of the sports bar 514 to select targeted dynamic presentations 5108, 142 or dynamic playlists 522, 524, 526, 528, 530, 532, 534, 536, 538, 540, 542. For example, in some embodiments, sensor 518 is a camera configured to collect image data of the lounge 502 of the sports bar 514. The Acme Bars Group Dynamic Nested Playlist Controller 522 may analyze the image data to determine an approximate average age of occupants in the lounge. The sensor 518 may also include an audio data collection element (e.g., a microphone) configured to record audio data for analysis by the Acme Bars Group Dynamic Nested Playlist Controller 522. The Acme Bars Group Dynamic Nested Playlist Controller 522 may analyze the image data and determine that the average age of occupants is 60 years old. Acme Bars Group Dynamic Nested Playlist Controller 522 may also analyze audio data to determine that an overall noise level of the lounge 502 is below 80 decibels, around 60 decibels, or relatively quiet in the context of a sports bar or an average noise level of the sports bar 514. Correlating these analyses to the tag values 124, 134 of regional tags 120, 132 indicating that the season in the region is fall, and that the time of day in the region is 1 pm, the Acme Bars Group Dynamic Nested Playlist Controller 522 may automatically select, from a repository, a dynamic presentation 108, 142 including calming fall-themed music and images advertising hot fall beverages served at the sports bar 514. Similarly, the Acme Bars Group Dynamic Nested Playlist Controller 522 may automatically select for display at mid-day in the lounge 502 a dynamic nested playlist 128, 130, 140, 142 of calming, fall-themed advertisements including the dynamic presentation 108, 142. The Acme Bars Group Dynamic Nested Playlist Controller 522 may then cause the displays 520 in the lounge 502 to display the selected dynamic nested playlist 128, 130, 140, 142. It is contemplated that the aforementioned repository of dynamic nested playlists 128, 130, 140, 142 may be locally connected to the Acme Bars Group Dynamic Nested Playlist Controller 522, or may be accessible as a remote service (e.g., a cloud storage service.) Similarly, it is contemplated that the Acme Bars Group Dynamic Nested Playlist Controller 522 may be disposed in the sports bar 514 itself, disposed in the surrounding area of the sports bar 514, or may be accessible as a remote service (e.g., a cloud computing service).

In the process of selecting a dynamic presentation 108, 142 or dynamic nested playlist 128, 130, 140, 142 the controller 102 may weight some tag values 124, 134 as more relevant than others. For example, the Acme Bars Group Dynamic Nested Playlist Controller 522 may determine, in light of user input, that the average age of the occupants in the lounge 502 should have a greater comparative weight than the noise level in selecting dynamic presentations 108, 142 or dynamic nested playlists 128, 130, 140, 142 for display as described above. For example, based on the observances described above, the Acme Bars Group Dynamic Nested Playlist Controller 522 may automatically create a rule 126, 130 (based on an analysis of the data driven dynamic tag values 110, 144) that both calming advertisements and advertisements targeted at older audiences should be added to a “lounge presentations” dynamic playlist 534. The Acme Bars Group Dynamic Nested Playlist Controller 522 may favor presentations, images, playlists, text, etc. targeted at older audiences while in correlating that rule 126, 130 to tags 120, 132 (e.g., tag names 122, 136 and tag values 124, 134), based on user input. Continuing with this example, a manager of the sports bar 514 may submit input (e.g., via a GUI) to the Acme Bars Group Dynamic Nested Playlist Controller 522 indicating that the average age of the occupants should be prioritized when generating, updating and selecting dynamic presentations 1108, 142 and dynamic nested playlists 128, 130, 138, 140.

In some embodiments, the parent dynamic nested playlist 128, 130, 138, 140 is a ‘master’ playlist accessible by a group of physical locations remote from one another. For example, advertisements in a dynamic nested playlist 522, 524, 526, 528, 530, 532, 534, 536, 538, 540, 542 shown on displays 520 in the sports bar 514 may also be shown on displays in an Irish Pub (not shown) using a shared dynamic nested playlist 524 but differently tagged displays 114. Continuing this example, a dynamic nested playlist 538 including advertisements for beer (shown in specific rooms in the Sports bar 514) may also be included in an “Irish pub ads” dynamic nested playlist 526 and shown in every area of the Irish Pub, while a dynamic nested playlist (not shown), containing whiskey advertisements, included under the ‘master’ dynamic nested playlist 524 and shared with but not shown in the Sports bar 514 is shown in the Irish Pub. This may occur, for example, because displays 520 in the Irish Pub may have tags 120 associated with displays 520 in the Irish Pub having tag names 122, 136 such as “product” and tag values 124, 134 such as “whiskey.”

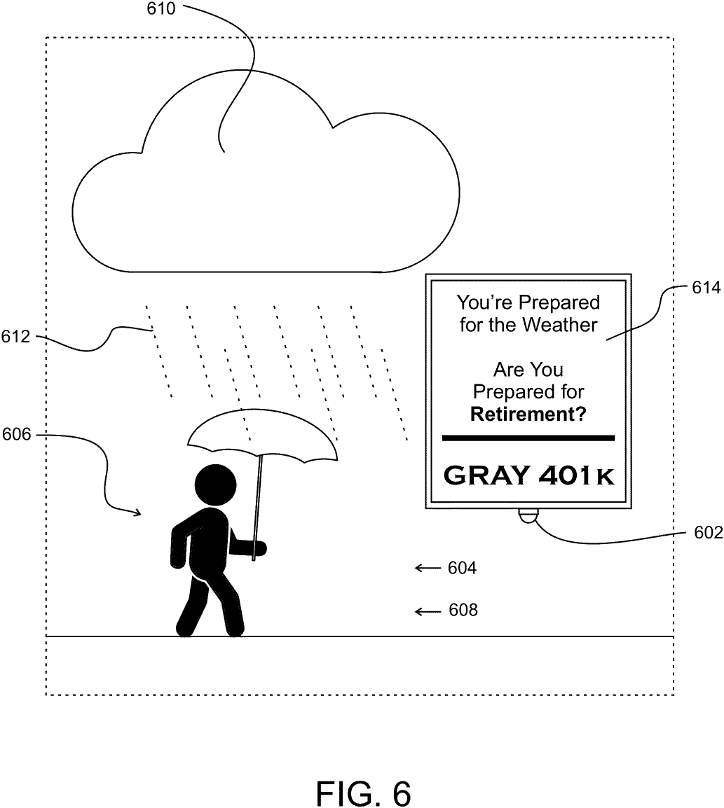

In reference to FIG. 6, sometimes the dynamic nested playlist system 111, 129 is configured to select a dynamic nested playlist 128, 130, 138, 140 or dynamic presentation 110, 142 without being assigned to an area of a specific venue. For example, sensor 602 may be an image sensor (e.g., a camera) configured capture images of an area 604 in front of the sensor 602. The sensor 602 is configured to communicate these images to the remote computing system 112 or to the electronic processor 104 via the input/output interface 116 or to the remote computing system 112. The dynamic nested playlist system 111, 129 may be configured to analyze the image (e.g., via the electronic processor 104 or the remote computing system 112), in real-time or according to a delay, and to update the data driven dynamic tag values 110, 144 via the memory 106 of the dynamic nested playlist system 111, 129 based on the analysis. For example, as target observants 606 pass the sensor 602, an image (not shown) collected by the sensor 602 may be analyzed by the dynamic nested playlist system 111, 129 before updating a tag 120, 132 having an associated tag name 122, 136 with a data driven dynamic tag value 110, 144. The dynamic nested playlist system 111, 129 may determine, based on the data driven dynamic tag values 110, 144 produced via image analysis, that the collected image depicts outdoor scenery 608, inclement weather 610, and a male target observer 606 of 30 to 40 years of age traversing the inclement weather 610 in the outdoor scenery 608. For Example, upon detecting the inclement weather 610, and determining that the inclement weather is rain 612, the dynamic nested playlist system 111, 129 may assign a value corresponding to rain for a data driven dynamic tag value 110, 144 for a tag 120, 132 corresponding to weather (e.g., a tag 120 having a tag name 122, 136 “weather”). Similarly, data driven dynamic tag values 110, 144 may be updated by the dynamic nested playlist system 111, 129 corresponding to the dynamic nested playlist system 111, 129 estimating the target observant’s 606 characteristics such as gender, height, weight, age, ethnicity, amount of jewelry, hair color, and so on.

The dynamic nested playlist system 111, 129 may select a dynamic presentation 110, 142 based on the data driven dynamic tag values 110, 144 and cause display 614 to display the dynamic nested playlists 128, 130, 138, 140 or dynamic presentations 110, 142. Specifically, the dynamic nested playlist system 111, 129 may select the dynamic nested playlist 128, 130, 138, 140 or dynamic presentation 110, 142 for display based on the data driven dynamic tag value 110, 144 as a means of targeting the target observer 606 as an intended viewer of the dynamic nested playlist 128, 130, 138, 140 or dynamic presentation 110, 142. The dynamic nested playlist 128, 130, 138, 140 or dynamic presentation 110, 142 may be pre-existing and present in the memory 106 of the dynamic nested playlist system 111, 129, or received by the dynamic nested playlist system 111, 129 from a remote computing system 112. For example, the dynamic nested playlist system 111, 129 may receive an update from a remote computing system 112 containing one or more dynamic presentations 108, 142. As another example, the dynamic nested playlist system 111, 129 may query the remote computing system 112 for a dynamic presentation 110, 142 suitable to the data driven dynamic tag value 110, 144, as needed. In some cases, the data driven dynamic tag value 110, 144 produced from the image analysis are not suitably matched to the dynamic presentations 108, 142 available in the memory 1106 of the dynamic nested playlist system 111, 129, and the dynamic nested playlist system 111, 129 may query remote computing system 112 for a dynamic presentation 110, 142 sufficiently suited to the data driven dynamic tag values 110, 144.

As described above, the dynamic nested playlist system 111, 129 is configured to select a dynamic presentation 110, 142 based on data driven dynamic tag values 110, 144 by processing the data driven dynamic tag values 110, 144 according to a set of rules 126, 130 that correlate the values of the data driven dynamic tag value 110, 144 to a set of tags 120 associated with one or more dynamic presentations 108, 142 or displays 114. For example, the tag names 122, 136 and tag values 124, 134 may be used by the dynamic nested playlist system 111, 129 in a search, and each tag name 122, 136 and tag value 124, 134 may point to a dynamic presentation 110, 142, a dynamic nested playlist 128, 130, 138, 140, a display 114. Referring to the example above, the dynamic nested playlist system 111, 129 may search memory 106 using the data driven dynamic tag values 110, 144 indicating the current weather (rain), the target observer 606 age (30 to 40 years), and the target observer 606 gender (male), using the data driven dynamic tag values 110, 144. The result of the search may be a dynamic nested playlist 128, 130, 138, 140 having tags 120 associated therewith having similar tag values 124, 134.

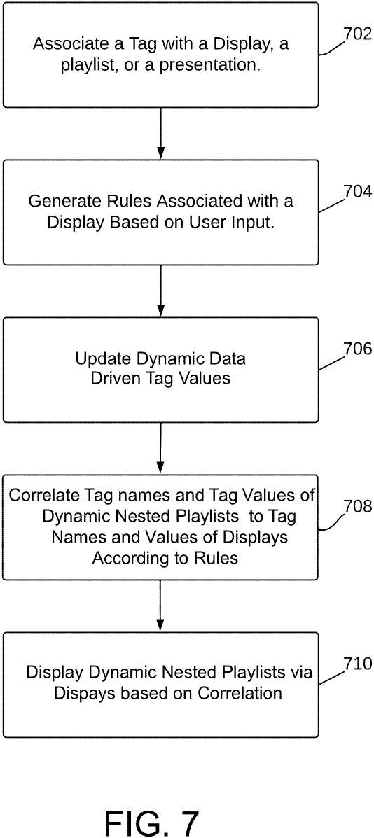

In reference to FIG. 7, a flow chart for generating or selecting dynamic nested playlists 128, 130, 138, 140 or dynamic presentations 108, 142 for display to a target observer 606 via a display 614.

At block 702, the dynamic nested playlist system 111, 129 may associate a tag 120 with a display 114, a dynamic nested playlist 128, 130, 138, 140, or a dynamic presentation 110, 142. The dynamic nested playlist system 111, 129 may automatically associate the tag 120 with the display 114, dynamic nested playlist 128, 130, 138, 140, or dynamic presentation 110, 142, or may make the association based on user input. For example, using a GUI 200, 300 as shown in FIGS. 2-3, a user may associate the tag 120 with the display 114, dynamic nested playlist 128, 130, 138, 140, or dynamic presentation 110, 142. As another example, in the case of an automatic association, the dynamic nested playlist system 111, 129 may prompt the user (e.g., via a GUI) for approval of an automatic association of the tag 120 with the display 114, dynamic nested playlist 128, 130, 138, 140, or dynamic presentation 110, 142.

At block 704, the dynamic nested playlist system 111, 129 may generate a rule 126, 130 based on user input via a GUI 400, as shown in FIG. 4. The dynamic nested playlist system 111, 129 may determine how to apply the rule to a display 114, a dynamic nested playlist 128, 130, 138, 140, or a dynamic presentation 110, 142 based on the phrasing (e.g., syntax) of the rule and context of the rule input. For example, a user may select, via a GUI 400, a particular display 114 or group of displays 114 and input a rule 126, 130 “thisItem.content != Political,” or some other syntax containing a self-referential parameter the dynamic nested playlist system 111, 129 may determine from the syntax. This rule 126, 130 will be used to evaluate data driven dynamic tag values 110, 144 during operation of the dynamic nested playlist system 111, 129.

At block 706, a sensor 118 such as a camera, a GPS, a light sensor, a distance sensor, an occupation sensor, a motion sensor, a humidity sensor, etc. may be used to populate data driven dynamic tag values 110 of a tag 120 having a tag name 122, 136 that can be reasonably associated with a data type. For example, GPS output may be used to populate a tag 120 having a tag name 122, 136 “location” with a GPS point as a data driven dynamic tag value 110, 144. Additionally, an occupation sensor may be used to populate a tag 120 having a tag name 122, 136 “occupation level” with an integer indicating an occupation count as a data driven dynamic tag value 110, 144. A network connection may also be used to update the value of a data driven dynamic tag value 110. For example, a data driven dynamic tag value 110 may be populated based on the results of an external network search (e.g., an internet search), based on the results of a database query, or some other request.

At block 708, the dynamic nested playlist system 111, 129 may correlate static, according to rules 126, 130, tag values 124, 134 or data driven dynamic tag values 124, 134 and tag names 122, 136 associated with dynamic presentations 108, 142 or dynamic nested playlists 128, 130, 1138, 140 to static tag values 124, 134 or data driven dynamic tag values 110 and tag names 122, 136 associated with displays 114. This correlation determines which displays 114 should display which dynamic presentations 108, 142 or dynamic nested playlists 128, 130, 1138, 140.

At block 710, the dynamic nested playlist system 111, 129 causes one or more displays 114 to display the dynamic presentations 108, 142 or dynamic nested playlists 128, 130, 138, 140 as determined via the correlation.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

Variation 1 may include a system comprising an input-output interface configured to communicate with a sensor and a display; a memory configured to store dynamic nested playlists, rules, and tags, the tags associated with one or more of the dynamic nested playlists and the display; an electronic processor coupled to the input-output interface and the memory, the electronic processor configured to select a suitable dynamic nested playlist by correlating one or more of the tags of the dynamic nested playlist to one or more tags associated with the display according to one or more of the rules; communicate presentation data included in the suitable dynamic playlist to the display.

Variation 2 may include the system of variation 1 wherein the dynamic nested playlists include dynamic presentations, and wherein the dynamic presentations include the presentation data.

Variation 3 may include the system of variations 1 and 2 wherein the sensor is a camera configured to capture image data.

Variation 4 may include the system of variations 1 through 3 wherein the electronic processor is configured to perform an image analysis of the image data, wherein the tag values are updated based on the image analysis.

Variation 5 may include the system of variations 1 through 4 wherein the rules are user-made.

Variation 6 may include the system of variations 1 through 5 wherein one or more of the tag values are data driven dynamic tag values.

Variation 7 may include the system of variations 1 through 6 wherein the suitable dynamic nested playlist is selected when the correlation according to the rules results in a 50% to 100% compatibility between at least one tag associated with the display and at least one tag associated with the suitable dynamic nested playlist.

Variation 8 may include method of displaying a dynamic presentation to a target observer comprising selecting, via the electronic processor, a dynamic nested playlist for display based on the correlating of a tag associated with the dynamic nested playlist to a tag associated with a display according to one or more rules; and, displaying, via the display, the dynamic nested playlist based on the selection of the dynamic nested playlist.

Variation 9 may include the method of claim 8, further comprising collecting data, via a sensor, and creating or updating, via the electronic processor, a data driven dynamic tag value of the tag values of the tag associated with the display or the tag associated with the dynamic nested playlist based on the data collected by the sensor.

Variation 10 may include the method of variations 8 and 9, wherein the sensor is a camera configured to collect image data.

Variation 11 may include the method of variations 8 through 10, wherein the method further includes performing, via the electronic processor, image analysis on the image data and creating or updating, via the electronic processor, the data driven dynamic tag value based on the image analysis.

Variation 12 may include the method of variations 8 through 11, further including accepting user input, via a graphical user interface, and creating or updating, via the electronic processor, the one or more rules based on the user input.

Variation 13 may include the method of variations 8 through 12, wherein one or more of the one or more tags are automatically associated with the display or the dynamic nested playlist by the electronic processor.

Variation 14 may include the method of variations 8 through 13, wherein selecting, via the electronic processor, a dynamic nested playlist for display based on the correlating of a tag associated with the dynamic nested playlist to a tag associated with a display comprises determining, via the electronic processor, a 50% to 100% compatibility between at least one tag associated with the display and at least one tag associated with the dynamic nested playlist.

Variation 15 may include a non-transitory computer readable medium that, when executed by an electronic processor, is configured to perform a set of functions, the set of functions comprising selecting a dynamic nested playlist for display based on the correlating of a tag associated with the dynamic nested playlist to a tag associated with a display according to one or more rules; and, displaying the dynamic nested playlist based on the selection of the dynamic nested playlist via a display.

Variation 16 may include the non-transitory, computer-readable medium of variation 15, further comprising instructions that, when executed by an electronic processor, are configured to perform a function of collecting data via a sensor, and updating the one or more data driven dynamic tag values of the tag associated with the display or the tag associated with the dynamic nested playlist based on the data collected by the sensor.

Variation 17 may include the non-transitory, computer-readable medium of variations 15 and 16, further comprising instructions that, when executed by an electronic processor, are configured to perform a function of collecting image data via a camera, wherein the sensor is the camera.

Variation 18 may include the non-transitory, computer-readable medium of variations 15 through 17, further comprising instructions that, when executed by an electronic processor, are configured to perform a function of performing image analysis on the image data and creating or updating the one or more data driven dynamic tag values of the tag associated with the display or the tag associated with the dynamic nested playlist based on the image analysis.

Variation 19 may include the non-transitory, computer-readable medium of variations 15 through 18, further comprising instructions that, when executed by an electronic processor, are configured to perform a function of accepting user input via a graphical user interface and creating or updating the one or more rules based on the user input.

Variation 20 may include the non-transitory, computer-readable medium of variations 15 through 19, wherein the selecting the suitable dynamic playlist based on the correlating of the one or more dynamic variables to the one or more tags comprises determining a 50% to 100% compatibility between at least one tag associated with the display and at least one tag associated with the dynamic nested playlist.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

Many different embodiments have been disclosed herein, in connection with the above description and the drawings. It will be understood that it would be unduly repetitious and obfuscating to describe and illustrate every combination and sub combination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or sub combination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a sub combination or variation of a sub combination.

It will be appreciated by persons skilled in the art that the present embodiment is not limited to what has been particularly shown and described hereinabove. A variety of modifications and variations are possible considering the above teachings without departing from the following claims.

What is claimed is:

1. A system comprising:
a display isolated from the target viewer configured to display presentation data including image data to a target viewer;
an input-output interface configured to communicate with a sensor isolated from the target viewer and the display;
a memory configured to store one or more dynamic nested playlists, rules, and tags, the tags associated with one or more of the dynamic nested playlists and the display;
an electronic processor coupled to the input-output interface and the memory, the electronic processor configured to:
identify a target viewer as an intended viewer of at least a portion of a suitable dynamic nested playlist;
capturing sensor data pertaining to the target viewer via the sensor,
select a suitable dynamic nested playlist including image data from the one or more dynamic nested playlists by correlating one or more of the tags of the dynamic nested playlist to one or more tags associated with the display according to one or more of the rules selected based on the sensor data pertaining to the target viewer;
communicate presentation data included in the suitable dynamic playlist to the display; and
display, via the display, the dynamic nested playlist based on the selection of the dynamic nested playlist as a means of targeting the target viewer.

2. The system of claim 1 wherein the dynamic nested playlists include dynamic presentations, and wherein the dynamic presentations include the presentation data.

3. The system of claim 1 wherein the sensor is a camera configured to capture data.

4. The system of claim 3 wherein the electronic processor is configured to perform an image analysis of the image data,
wherein the tag values are updated based on the image analysis.

5. The system of claim 1 wherein the rules are user-made.

6. The system of claim 1 wherein one or more of the tag values are data driven dynamic tag values.

7. The system of claim 1 wherein the suitable dynamic nested playlist is selected when the correlation according to the rules results in a 50% to 100% compatibility between at least one tag associated with the display and at least one tag associated with the suitable dynamic nested playlist.

8. A method of displaying a dynamic presentation to a target observer comprising:
collecting data, via a sensor configured to capture data, pertaining to the target viewer;
selecting, via the electronic processor, a dynamic nested playlist including image data for display based on the correlating of a tag associated with the dynamic nested playlist to a tag associated with a display according to one or more rules selected based on the sensor data; and,
displaying, via the display, the dynamic nested playlist based on the selection of the dynamic nested playlist, and
wherein the display is configured to display presentation data including image data to the target viewer.

9. The method of claim 8, further comprising:
creating or updating, via the electronic processor, a data driven dynamic tag value of the tag values of the tag associated with the display or the tag associated with the dynamic nested playlist based on the data collected by the sensor.

10. The method of claim 9, wherein the sensor is a camera configured to collect data.

11. The method of claim 10, wherein the method further includes performing, via the electronic processor, image analysis on the image data and
creating or updating, via the electronic processor, the data driven dynamic tag value based on the image data analysis.

12. The method of claim 8, further including accepting user input, via a graphical user interface, and
creating or updating, via the electronic processor, the one or more rules based on the user input.

13. The method of claim 8, wherein one or more of the one or more tags are automatically associated with the display or the dynamic nested playlist by the electronic processor.

14. The method of claim 8, wherein selecting, via the electronic processor, a dynamic nested playlist for display based on the correlating of a tag associated with the dynamic nested playlist to a tag associated with a display comprises
determining, via the electronic processor, a 50% to 100% compatibility between at least one tag associated with the display and at least one tag associated with the dynamic nested playlist.

15. A non-transitory computer readable medium that, when executed by an electronic processor, is configured to perform a set of functions, the set of functions comprising:
collecting data, via at least one sensor comprising at least one camera configured to capture data pertaining to a target viewer;
selecting a dynamic nested playlist including image data for display based on the correlating of a tag associated with the dynamic nested playlist to a tag associated with a display according to one or more rules selected based on the sensor data; and,
displaying the dynamic nested playlist based on the selection of the dynamic nested playlist via a display, and
wherein the display is configured to display presentation data including image data to the target viewer.

16. The non-transitory, computer-readable medium of claim 15, further comprising instructions that, when executed by an electronic processor, are configured to perform a function of:
collecting data via a sensor, and
updating the one or more data driven dynamic tag values of the tag associated with the display or the tag associated with the dynamic nested playlist based on the data collected by the sensor.

17. The non-transitory, computer-readable medium of claim 15, further comprising instructions that, when executed by an electronic processor, are configured to perform a function of:
collecting image data via a camera,
wherein the sensor is the camera.

18. The non-transitory, computer-readable medium of claim 17, further comprising instructions that, when executed by an electronic processor, are configured to perform a function of:
performing image analysis on the image data and
creating or updating the one or more data driven dynamic tag values of the tag associated with the display or the tag associated with the dynamic nested playlist based on the image analysis.

19. The non-transitory, computer-readable medium of claim 17, further comprising instructions that, when executed by an electronic processor, are configured to perform a function of:
accepting user input via a graphical user interface, and
creating or updating the one or more rules based on the user input.

20. The non-transitory, computer-readable medium of claim 17, wherein the selecting the suitable dynamic playlist based on the correlating of the one or more dynamic variables to the one or more tags comprises
determining a 50% to 100% compatibility between at least one tag associated with the display and at least one tag associated with the dynamic nested playlist.
